(19) United States
(12) Patent Application Publication
(10) Pub. No.: US 2007/0182977 A1
(43) Pub. Date: Aug. 9, 2007

(54) Printing subsystem with improved user interface

(75) Inventors: Andrew T. Martin, Honeoye Falls, NY (US); Ken Hayward, Brockport, NY (US); Shane Jewitt, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/350,217

(22) Filed: Feb. 8, 2006

(51) Int. Cl. G06F 3/12

(52) U.S. Cl. 358/1.13; 715/700

(57) ABSTRACT

An improved user interface for a printing subsystem is provided. The user interface includes a dialog with first, second and third display fields. In practice, an indicator corresponding with a job (the job including one or more documents and a job ticket) is displayed in the first display field, an indicator corresponding with the document or multiple documents is displayed in the second display field, and an indicator corresponding with the job ticket is displayed in the third display field. The first, second, and third display fields are positioned on the dialog in such a way that a hierarchy and relationships between the job, the document and the job ticket is clearly visible from the dialog.

### BACKGROUND AND SUMMARY

The disclosed embodiments relate to a system and method for facilitating print job programming in a printing subsystem. The system and method permit a user to fully comprehend, among other things, the relationship between three items on a single user interface dialog, namely the relationship between a saved job, its underlying document and associated job ticket (i.e., printing instructions). This is achieved, at least in part, through establishing a visual and behavioral relationship between the three items such that the effect of changing one of the three items can be seen in one or both of the other two items.

In a conventional digital printing system, a job is provided to a printing subsystem, with an input section, in the form of a digital master. The master or “job” includes print-related information (image data) and a set of control signals representing programming instructions. In one common example, prints for the job are produced from image data or an underlying document (hereinafter referred to simply as “document”) by reference to the printing instructions of the associated job ticket. As is known, the document may be obtained from an image capture device, e.g. a scanner, or a network connection in the form of a page description language (PDL). As is also known, the job ticket may be programmed at a host-printing device or provided with a network job in the PDL format.

The document and the job ticket may be stored in memory and, at print time, copies of the document and job ticket are transferred to a print queue for eventual production of prints with a conventional print engine. Further details regarding the management of a job (along with its attendant job ticket) in a digital printing system is provided in U.S. Pat. Nos. 5,164,842, 5,493,634, and 5,718,520 the pertinent portions of which are incorporated herein by reference.

Basic concepts underlying the design and use of graphic user interfaces in the context of computing or printing systems are described, in detail, in U.S. Pat. Nos. 4,939,507, 5,079,723, and 5,168,441, the pertinent portions of which are incorporated herein by reference. It will be appreciated by those skilled in the art that basic software support for a typical user interface platform can be readily implemented through use of one of several publicly available programming languages, such as Xerox's “Smalltalk,” or “Viewpoint,” some of which programming languages were publicly and extensively disclosed over two decades ago at Xerox's Palo Alto Research Center (“PARC”). As will be understood, other currently available languages, such as C++, C#, JAVA and Linux, could also be used, in a conventional manner, to implement the above-mentioned graphic user interface design.

As disclosed by U.S. Pat. Nos. 5,442,732 and 5,715,381, the pertinent portions of which are incorporated herein by reference, a group of jobs can be printed as a single job. In short, a plurality of jobs can be grouped in a “package” or folder and processed as a single “super set” with a single corresponding job ticket. As taught by the '732 patent.
Although the concept of a “folder” is known in certain graphical user interfaces (GUIs) for PCs and workstations, this invention introduces the concept of a print folder to electronic reprographic systems. The essential difference between a print folder and a folder for a GUI is that the print folder conceptually links jobs for printing that are part of the conceptual document. As such, a print folder has additional properties not found in folders for GUIs. These properties include the quantity selected for printing, a finishing selection for the consolidated jobs contained in or referenced by the folder, and selections for controlling set offset between sets and supersets. Further, the print folder process described offers the option of automatic chapter starts for each job within the folder.

Job programming or submission for a system of the type disclosed in the above-mentioned '842 and '520 patents can be straightforward when the user of such system simply intends to print a copy of a stored or saved job. For instance, referring to FIG. 13 of the '842 patent, the user can employ a menu, accessed by selecting a job icon, to execute printing of a corresponding job in accordance with the described approach above. When using the interrelated concepts of documents, job tickets and saved jobs pursuant to a job submission process, however, the actual relationship and hierarchy of these concepts or items can be confusing to the user. If the user does not understand the relationship between these items, the user can inadvertently overwrite contents or parameters of his or her jobs and ultimately receive undesirable output. Currently the relationship between these items is not handled effectively in job submission dialogs. The three items are scattered throughout the dialog, not clearly defined, and not behaviorally related.

In accordance with the one aspect of the disclosed embodiments, there is provided a printing subsystem comprising: a memory for storing one or more jobs, a first one of the one or more jobs including a document and a job ticket with one or more printing instructions; a user interface; a processor operatively associated with each one of the memory and the user interface for transmitting information about each one of the first one of the one or more jobs, the document and job ticket to the user interface; the user interface including a dialog, the dialog having a first display field, a second display field and a third display field, wherein an indicator corresponding with the first one of the one or more jobs is displayed in the first display field, an indicator corresponding with the document is displayed in the second display field, and an indicator corresponding with the job ticket is displayed in the third display field; and the first, second, and third display fields are positioned on the dialog in such a way that a hierarchical relationship between the first one of the one or more jobs, the document and the job ticket is clearly visible on the dialog.

In accordance with another aspect of the disclosed embodiments, there is provided a user interface for a printing subsystem, the printing subsystem including memory for storing one or more jobs, a first one of the one or more jobs including a document and a job ticket with one or more printing instructions, comprising: a dialog, the dialog having a first display field, a second display field and a third display field, wherein an indicator corresponding with the first one of the one or more jobs is displayed in the first display field, an indicator corresponding with the document is displayed in the second display field, and an indicator corresponding with the job ticket is displayed in the third display field; and the first, second, and third display fields are positioned on the dialog in such a way that a hierarchical relationship between the first one of the one or more jobs, the document and the job ticket is clearly visible on the dialog.

In accordance with yet another aspect of the disclosed embodiments, there is provided a method for programming a job in a printing subsystem, the job including a document and a job ticket with one or more printing instructions, comprising: (a) providing a dialog including a first display field, a second display field and a third display field; (b) displaying an indicator corresponding with the job in the first display field; (c) displaying an indicator corresponding with the document in the second display field; displaying an indicator corresponding with the job ticket in the third display field; and (e) positioning the first, second, and third display fields on the dialog in such a way that a hierarchical relationship between the job, the document and the job ticket is clearly visible on the dialog.

### BRIEF DESCRIPTION OF THE DRAWINGS

FIG. 1 is a block diagrammatic view of a digital printing system in which the disclosed embodiments may be incorporated;

FIG. 2 is a block diagrammatic view showing selected subsystems of the digital printing system of FIG. 1;

FIG. 3 is a perspective view illustrating a few of the components comprising the user interface of FIG. 2;

FIG. 4 is an elevational view of a job set-up or submission screen for a user interface in which the fields relating respectively to saved jobs, saved tickets and documents are shown in a hierarchical relationship;

FIG. 5 is a partial elevational view of the job submission screen of FIG. 4 in which a dropdown menu relating to “Save Job” is shown;

FIG. 6 is a partial elevational view of the job submission screen of FIG. 4 in which a “Document(s):” field and a group of “Job Setup:” buttons are shown; and

FIG. 7 is a partial elevational view of the job submission screen of FIG. 4 in which an exemplary dropdown list of “Saved Tickets:” is shown.

### DETAILED DESCRIPTION

While the disclosed embodiments will hereinafter be described in connection with one or more embodiments thereof, it will be understood that it is not intended to limit the claimed invention to such one or more embodiments. On the contrary, it is intended to cover all alternatives, modifications and equivalents as may be included within the spirit and scope of the invention as defined in the appended claims.

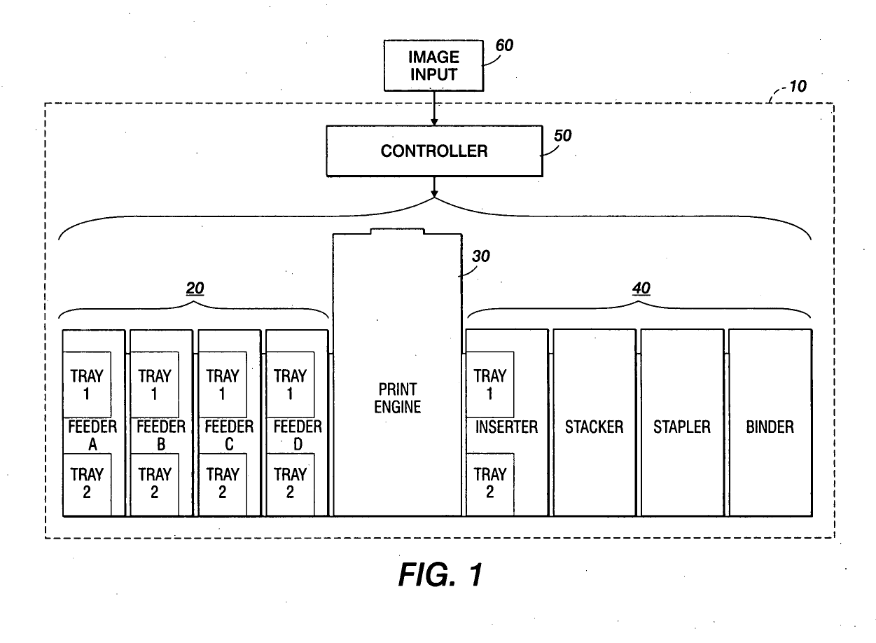

Referring now to the drawings, FIG. 1 shows a digital printing system 10 of the type suitable for use with the disclosed embodiments for processing print jobs. As shown, the digital printing system includes document feeders 20, a print engine 30, finishers 40, and controller 50. The digital printing system 10 is coupled to an image input section 60.

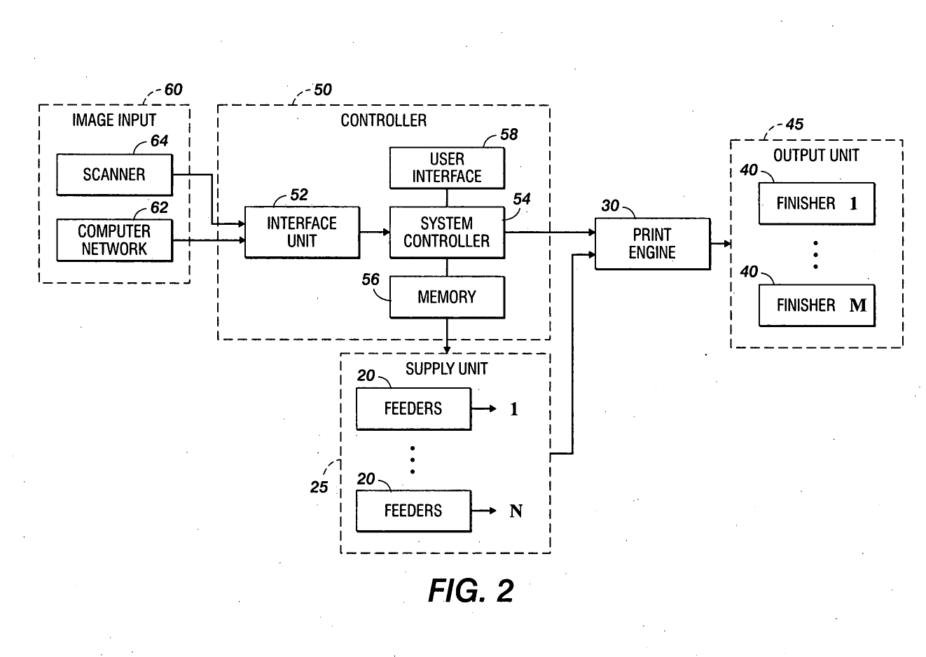

As shown in FIG. 2, the image input section 60 transmits signals to the controller 50. In the example shown, image input section 60 has both remote and onsite image inputs, enabling the digital printing system 10 to provide network, scan and print services. In this example, the remote image input is a computer network 62, and the onsite image input is a scanner 64. However, the digital printing system 10 can be coupled to multiple networks or scanning units, remotely or onsite. Other systems can be envisioned such as stand-alone digital printing system with on-site image input, controller and printer.

The digital printing system 10 can receive image data, the image data including pixels, in the form of digital image signals for processing from the computer network 62 by way of a suitable communication channel, such as an Ethernet® connection. Typically, computer networks 62 include clients who generate jobs, wherein each job includes the image data in the form of a plurality of electronic pages and a set of processing instructions. In turn, each job is converted into a representation written in a page description language (PDL) such as PostScript® containing print related information (including the image data). Where the PDL of the incoming print related information is different from the PDL used by the digital printing system, a suitable conversion unit converts the incoming PDL to the PDL used by the digital printing system. The suitable conversion unit may be located in an interface unit 52 of the controller 50. Other remote sources of image data such as a floppy disk, hard disk, storage medium, scanner, etc. may be envisioned.

For on-site image input, an operator may use the scanner 64 to scan documents, thus providing digital image data including pixels to the interface unit 52. Whether digital image data is received from scanner 64 or computer network 62, the interface unit 52 processes the digital image data in the form required to carry out each programmed job. The interface unit 52 is preferably part of the digital printing system 10. However, the components in the computer network 62 or the scanner 64 may share the function of converting the digital image data into a form, which can be unutilized by the digital printing system 10.

As indicated previously, the digital printing system 10 includes feeders 20, print engine 30, finishers 40, and controller 50. Each feeder 20 preferably includes one or more trays 22, which forward different types of support material to the print engine 30. All of the feeders 20 in the digital printing system 10 are collectively referred to as a supply unit 25. All of the finishers 40 are collectively referred to as an output unit 45. The output unit 45 may comprise several types of finishers 40, such as inserters, stackers, staplers and binders, which take the completed pages from the print engine and use them to provide a finished product.

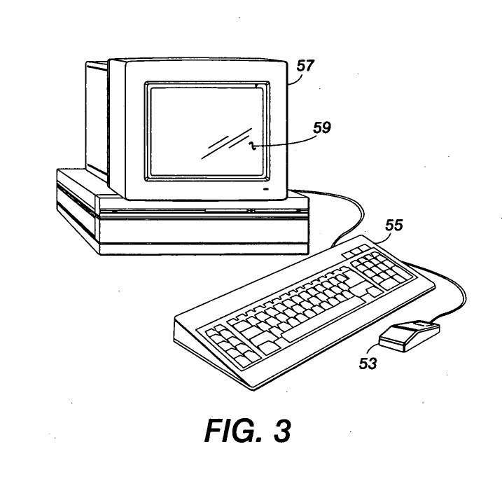

The controller 50 controls and monitors the entire digital printing system 10 and interfaces with both on-site and remote input units in the image input section 60. The controller 50 includes the interface unit 52, a system control unit 54, a memory 56 and a user interface 58. The user interface 58 includes, among other things, an area holding a graphic representation or picture of the feeders 20, print engine 30 and finishers of the digital printing system 10. The user interface 58 permits an operator to monitor the document feeders 20, print engine 30 and finishers 40 by navigating through a series of menus by clicking on a section of the graphical representation of the user interface 58 to reach controls or information related to that component of the digital printing system 10. Therefore, a user (also called an operator) can associate tasks done on the user interface 58 with their physical location on the digital printing system 10 and thereby enable faster and more intuitive navigation. In one example, as shown in FIG. 3, the user interface 58 includes a display screen 53, a keyboard 55 and a mouse 57.

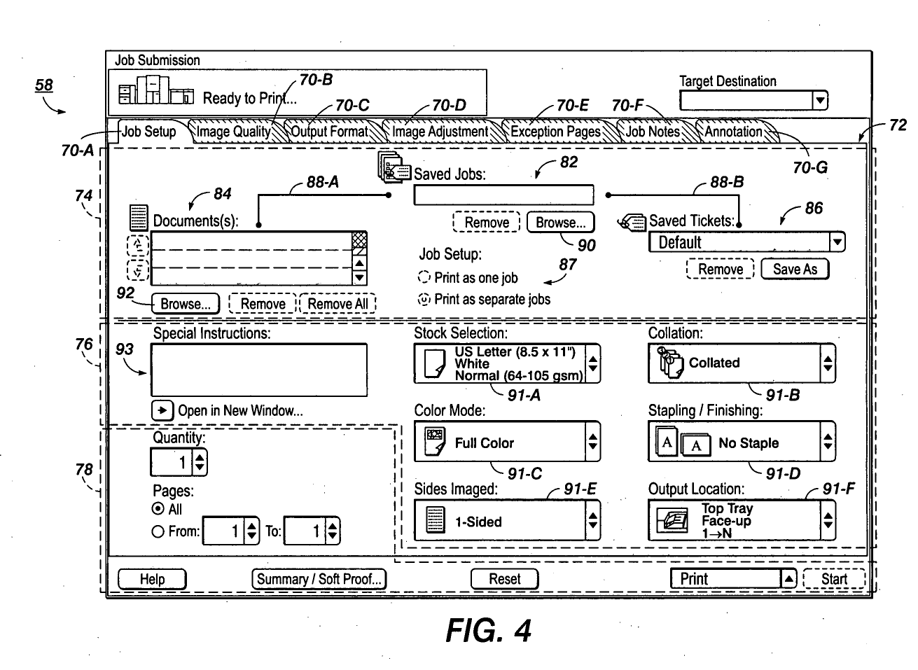

Referring to FIG. 4, one aspect of the user interface 58 is described in some detail. It should be noted that the user interface includes a “layered dialog” in which a user can access one of several user dialogs or screens by selecting from one of “tabs” 70-A through 70-G. A detailed discussion regarding the use of a layered dialog, in the context of a printing system, is provided in the above-mentioned U.S. Pat. No. 5,079,723. Upon selection of tab 70-A, a screen 72 for general set up of a job is displayed. As shown in FIG. 4, the screen 72, which could be a touch or mouse selectable screen, is divided into sections 74, 76 and 78.

Referring first to section 74, a “Saved Jobs” display field (referred to simply as “field” hereinafter) 82 is positioned above “Document(s):” field 84 and “Saved Tickets:” field 86. Suitable icons respectively identify the fields, and the hierarchical relationship between the associated concepts (namely saved jobs, document(s) and saved tickets) is accentuated with indicator lines 88-A and 88-B. A conventional browsing system, for retrieving data locally or remotely, is associated with each one of the fields 82 and 84. “Browse” buttons 90 and 92 may be employed to view (and possibly retrieve) data stored either in memory 56 (FIG. 2) or on the network (via network computer 62). Additionally, field 86 is provided with a dropdown menu (shown in FIG. 7) to assist the user in managing his or her saved job tickets. Finally a “Job Setup” button group 87 (further shown in FIG. 6), the significance of which will be discussed below, is positioned between fields 84 and 86.

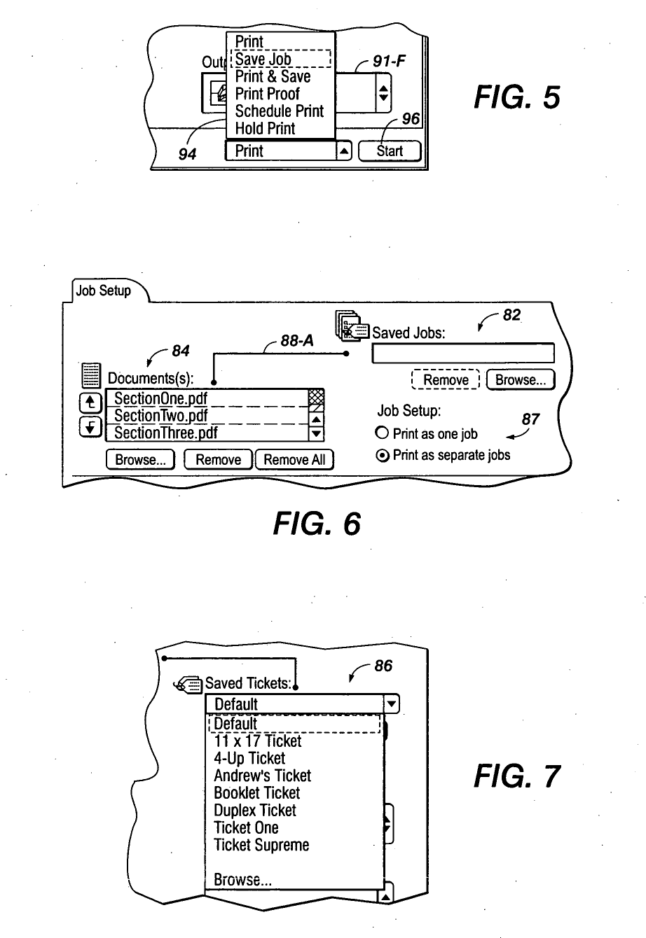

Referring to section 76 of FIG. 4, additional fields 91-A through 91-F (along with accompanying dropdown menus) are provided to facilitate programming of a job ticket. Another field 93 is provided for input of special instructions. Referring to section 78, a variety of controls (including print/save dropdown menu 94 (see FIG. 5), the significance of which will be discussed further below) are provided.

Three concepts, among others, are important to understanding the disclosed control scheme of FIG. 4, namely “Documents,” “Job Tickets,” and “Jobs.” As mentioned above, documents are the electronic files that contain the PDL data, essentially the content to be printed. A job ticket is the set of instructions that define how the documents are to be printed. The job ticket typically includes instructions that are interpreted directly by the printing device as well as information that might be used by downstream processes, such as offline finishing or fulfillment. These job tickets can be saved and recalled by system operators. A job is the combination of the document(s) and the job ticket. Jobs can also be saved and recalled by an operator. The controls of FIG. 4 are organized in a way that makes the hierarchy and relationships between the concepts clear from screen 72; a job is comprised of one or more documents and a job ticket; and the documents and job tickets exist independently.

Behaviorally, when the user recalls a valid saved job either by typing part or all of a valid job in the saved job field 82, or through use of the browsing system 90, the document(s) field 84 and saved tickets field 86 are automatically populated with objects contained within the saved job displayed in the field 82. Referring to FIG. 5, if the user wishes to save a job from within the job set up screen or dialog 72, he or she would select either the Save Job or Print and Save option from the dropdown menu 94 associated with a Start button 96. If either of these options were selected and the Start button 96 was pressed, a Save dialog would be presented automatically. The Save dialog is presented in this context because it is an execute function that links the currently displayed document(s) with the currently displayed job ticket, and can potentially save them pre-formatted for quick printing.

Referring to FIG. 6 (in conjunction with FIG. 4), for “simple” submissions the user can select single or multiple printable files using the Document(s) controls (associated on the screen 72 around field 84) without specifying a stored Job or ticket. If multiple documents are selected the user can re-order them using the Document(s) controls to the left of the field 84. Additionally, the user can also choose to print multiple documents listed in field 84 as one job or as individual jobs, with the same job ticket, by simply selecting a user selectable control which, in the example of FIGS. 4 and 7, comprise a Job Setup button group 87 (adjacent field 84). Additionally the user can remove one or more of the documents from the list in field 84 before submission using the Remove or Remove All buttons.

Referring to FIG. 7, a user can also select saved tickets to be used with a corresponding saved job. An example of such approach is accomplished by accessing the dropdown menu associated with field 86. That dropdown menu contains a list of local or favorite tickets, and also provides the ability to browse for stored tickets. Once a stored ticket is selected, the settings in section 76 of the Job Setup dialog 72 (FIG. 4), as well as the settings contained within the tab set 70-A through 70-G, would be changed to reflect the settings defined in the ticket. It should be noted that in the absence of a user selected stored ticket there is always a default ticket that, in effect, includes default settings associated with the host printer. Additionally, in one example of operation, if the user modifies the settings of either the default ticket or a saved ticket the system essentially creates a local ticket that is named “user Defined”.

Whether job programming begins by retrieving a saved job or mapping a saved job ticket to one or more documents, a user can subsequently change settings after the job or ticket are recalled. If this is done one or more of the settings contained in the fields 91-A through 91-F would be changed to reflect that some of the original settings for the job or ticket have been changed.

Based on the above description, several features of the disclosed embodiment(s) should now be evident:

First, a user interface with a screen clearly showing the relationship between a job and its associated components (namely its underlying document(s) and associated job ticket) has been provided. The relationship is clarified in several ways:
Fields corresponding respectively with “Saved Jobs,” “Document(s),” and “Saved Tickets (including the currently selected, default, user defined or saved job ticket)” are displayed hierarchically so that a user can readily see the relationship between these concepts;
The fields are shown compactly on a single screen so that a user does not have to “lip” through multiple screens pursuant to programming a job; and
The relevant screen is provided with multiple visual aids, such as icons and connectors that further accentuate understanding of the above-mentioned concepts.

Second, a high degree of flexibility and capability is provided in the area of job ticket usability. In one aspect of usage, the user is automatically provided with associated job ticket and underlying document(s) indicators in response to selecting a saved job indicator. In this way the user is provided not only with a visual hierarchy, but with a comprehensive perspective of the dynamic relationships between the concepts of “Saved Job,” “Document(s),” and “Saved Ticket.” Changes to a number of important printing instructions of the associated job ticket can be made at the same screen on which the indicators are displayed prior to printing an underlying document (an indicator for such underlying document also being displayed automatically on the same screen). In another aspect of usage, job tickets can readily be “mixed and matched” with one or more documents. For example, the user may access a list of saved job tickets and replace the automatically provided associated job ticket with one of the saved job tickets from a list of saved job tickets.

Finally, the programming approach disclosed above should greatly facilitate the already useful area of “older” or “package” printing. Building on a very flexible and capable screen for job programming, a list of documents to be printed and a saved job ticket can be readily and quickly corresponded on a single screen. Then, in accordance with a multiple mode capability, the documents can be printed individually, in one mode, or as a single document, in another mode. The many advantageous possibilities made available by the capability of mixing and matching multiple document indicators with a job ticket indicator (selected from a list of saved job tickets) on the same screen, and then printing the underlying documents in accordance with the multi-mode capability can be readily appreciated by those skilled in the art.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A printing subsystem, comprising:
a memory for storing one or more jobs, a first one of the one or more jobs including a document and a job ticket with one or more printing instructions;
a user interface;
a processor operatively associated with each one of said memory and said user interface for transmitting information about each one of the first one of the one or more jobs, the document and job ticket to said user interface;
said user interface including a dialog, said dialog having a first display field, a second display field and a third display field, wherein an indicator corresponding with the first one of the one or more jobs is displayed in the first display field, an indicator corresponding with the document is displayed in the second display field, and an indicator corresponding with the job ticket is displayed in the third display field; and
the first, second, and third display fields being positioned on said dialog in such a way that a hierarchical relationship between the first one of the one or more jobs, the document and the job ticket is clearly visible on the dialog.

2. The printing subsystem of claim 1, in which the first one of the one or more jobs comprises a first document, and the job ticket comprises a first job ticket, and in which a second job, comprising a second document and a second job ticket, is stored in the memory, wherein when an indicator for the second job is displayed in the first display field in place of the indicator for the first one of the one or more jobs, an indicator corresponding with the second document is automatically displayed in the second display field in place of the indicator for the first document, and an indicator corresponding with the second job ticket is automatically displayed in the third display field in place of the indicator for the first job ticket.

3. The printing subsystem of claim 1, in which a plurality of indicators, corresponding respectively with a plurality of documents, is displayed in the second display field, further comprising a user selectable control on the dialog for disposing the system in one of a first mode and a second mode, the printing subsystem being instructed to print each one of the plurality of documents individually when the user selectable control is disposed in the first mode, and being instructed to print the plurality of documents as a single document when the user selectable control is disposed in the second mode.

4. The printing subsystem of claim 1, further comprising a dropdown menu operatively associated with the third display field, wherein the dropdown menu includes a list having at least one saved job ticket associated with one or more printing instructions, and wherein an indicator corresponding with the at least one saved job ticket is displayed in the third display field, in place of the job ticket, when the at least one saved job ticket is selected from the list so that the document is printed in accordance with the one or more printing instructions of the at least one saved job ticket.

5. A user interface for a printing subsystem, the printing subsystem including memory for storing one or more jobs, a first one of the one or more jobs including a document and a job ticket with one or more printing instructions, comprising:
a dialog, said dialog including a first display field, a second display field and a third display field, wherein an indicator corresponding with the first one of the one or more jobs is displayed in the first display field, an indicator corresponding with the document is displayed in the second display field, and an indicator corresponding with the job ticket is displayed in the third display field; and
said first, second, and third display fields are positioned on said dialog in such a way that a hierarchical relationship between the first one of the one or more jobs, the document and the job ticket is clearly visible on the dialog.

6. The user interface of claim 5, in which the document comprises a first document, and the job ticket comprises a first job ticket, and in which a second job, comprising a second document and a second job ticket, is stored in the memory, wherein when an indicator for the second job is displayed in the first display field in place of the indicator for the first one of the one or more jobs, an indicator corresponding with the second document is automatically displayed in the second display field in place of the indicator for the first document, and an indicator corresponding with the second job ticket is automatically displayed in the third display field in place of the indicator for the first job ticket.

7. The user interface of claim 5, in which the document comprises a first document with a first indicator, and in which a second document is introduced to the printing subsystem, wherein the first indicator corresponding with the first document and a second indicator corresponding with the second document are simultaneously displayed in the second display field.

8. The user interface of claim 7, wherein the second display field is configured in such a way that an order of the first and second indicators can be changed.

9. The user interface of claim 5, in which the dialog is partitioned into a first portion and a second portion, wherein the first, second and third display fields are located in said first portion, and wherein said second portion includes fields useable for programming the job ticket.

10. The user interface of claim 5, in which a plurality of indicators, corresponding respectively with a plurality of documents, is displayed in the second display field, further comprising a user selectable control on the dialog for disposing the system in one of a first mode and a second mode, the printing subsystem being instructed to print each one of the plurality of documents individually when the user selectable control is disposed in the first mode, and being instructed to print the plurality of documents as a single document when the user selectable control is disposed in the second mode.

11. The user interface of claim 5, in which the dialog includes a vertical axis, wherein, relative to the vertical axis, each one of the second and third display fields is positioned below the first display field to emphasize said hierarchical relationship.

12. The user interface of claim 5, further comprising a dropdown menu operatively associated with the third display field, wherein the dropdown menu includes a list having at least one saved job ticket with one or more printing instructions, and wherein an indicator corresponding with the at least one saved job ticket is displayed in the third display field, in place of the job ticket, when the at least one saved job ticket is selected from the list so that the document is printed in accordance with the one or more printing instructions of the at least one saved job ticket.

13. The user interface of claim 12, wherein the user interface is provided with the capability to permit user editing of one of the one or more printing instructions of the at least one saved job ticket

14. The user interface of claim 12, wherein said list further includes a ticket with one or more default printing instructions.

15. The user interface of claim 5, further comprising a set of visual aids on the dialog for identifying the hierarchical relationship between the first, second and third display fields.

16. A method for programming a job in a printing subsystem, the job including a document and a job ticket with one or more printing instructions, comprising:
(a) providing a dialog including a first display field, a second display field and a third display field;
(b) displaying an indicator corresponding with the job in the first display field;
(c) displaying an indicator corresponding with the document in the second display field;
(d) displaying an indicator corresponding with the job ticket in the third display field; and
(e) positioning the first, second, and third display fields on the dialog in such a way that a hierarchical relationship between the job, the document and the job ticket is clearly visible on the dialog.

17. The method of claim 16, wherein said (c) and (d) occur in response to said (b).

18. The method of claim 17, further comprising changing at least one of the one or more printing instructions.

19. The method of claim 16, in which the job ticket comprises a first job ticket, further comprising displaying an indicator corresponding with a second job ticket having one or more printing instructions in the third display field in place of the first job ticket so that the document is printed in accordance with the one or more printing instructions of the second job ticket.

20. The method of claim 16, in which the job is a first job and the document is a first document, further comprising displaying an indicator corresponding with a second job in the first display field in place of the indicator for the first job, and displaying an indicator corresponding with a second document in the second display field in place of the indicator for the first document, wherein the second document is processed for printing with the job ticket.

21. The method of claim 16, in which the document is a first document, further comprising simultaneously displaying an indicator corresponding with a second document in the second display field along with the indicator for the first document.

22. The method of claim 21, further comprising disposing the printing subsystem in one of a first mode and a second mode, wherein the printing subsystem is instructed to print each one of the first and second documents individually when the printing subsystem is disposed in the first mode, and wherein the printing subsystem is instructed to print the first and second documents as a single document when the printing subsystem is disposed in the second mode.
